(19) United States
(12) Patent Application Publication
(10) Pub. No.: US 2007/0092365 A1
(43) Pub. Date: Apr. 26, 2007

(54) Low approach angle cargo flatbed assembly

(76) Inventor: Brian Filiatreault, Salem, WI (US)

Correspondence Address: MICHAEL J. BERGNACH, 822 SHERIDAN ROAD, KENOSHA, WI, 53140, US

(21) Appl. No.: 11/256,892

(22) Filed: Oct. 21, 2005

(51) Int. Cl. B60P 1/04

(52) U.S. Cl. 414/491

(57) ABSTRACT

A flatbed assembly for a material handling vehicle has a bed configured to support a cargo load during transportation, loading and unloading. The flatbed assembly has a receptacle that engages a positioning apparatus on the material handling vehicle such that the positioning apparatus can move and position the flatbed assembly. The flatbed assembly can be completely moved off of the material handling vehicle by the positioning apparatus to a cargo loading position with or without a load of cargo. Further, the positioning apparatus can move the flatbed assembly back to a transporting position on the material handling vehicle with or without a load of cargo. The flatbed assembly further has a landing gear assembly at the rear of the bed to engage a ground surface during positioning of the flatbed assembly and to minimize the height of said bed relative to the ground surface.

### BACKGROUND OF THE INVENTION

The present invention relates, in general, to apparatuses for supporting and transporting cargo, especially vehicles, with material handling vehicles and/or tow trucks. More specifically, the present invention relates to a flatbed assembly, useable with material handling vehicles and/or tows trucks, such that the flatbed assembly is configurable into a low approach angle position for loading and unloading cargo, especially vehicle cargo. After loading, the present flatbed assembly with cargo load is movable back into a transport position on the material handling vehicle and/or tow truck. Further, the present flatbed assembly can adjustably contact a ground surface having various ground surface conditions, such as uneven terrain.

Currently, there exist material handling vehicles and/or tow trucks that have trailers, flatbed cargo areas, or other apparatuses for transporting cargo, especially vehicle cargo. Typically, during loading, the vehicle cargo would be driven up a loading surface of the truck, such as a ramp that connects the ground surface to the cargo area of the truck, where the vehicle can be secured for transportation. Also, there currently exist flatbed-type tow trucks that have partially retractable beds, such that the bed can be partially moved off of the rear of the truck into a loading position, where the bed is inclined to contact the ground surface and, thus, the bed becomes a ramp-like loading surface. Because the inclined bed is so steep, a winch typically pulls the vehicle cargo up into the cargo area of the truck. The bed is then retracted with cargo into a transporting position. Due to the ground contacting configurations of these material handling vehicles, these trucks can reduce the need for heavy cargo lifting equipment and special cargo loading docks to load cargo, especially vehicle cargo. Nevertheless, these currently existing material handling vehicles and other material handling vehicles have limitations and problems.

One of the biggest limitations of material handling vehicles or tow trucks is that the inclination of the loading surface is too great or too steep. Because the cargo area or the truck chassis itself is relatively high off of the ground, the loading surface must necessary have a big angle for the loading surface to contact both the ground surface and the cargo area or chassis. This steep approach angle configuration creates many problems and difficulties for loading and unloading cargo. All types of cargo are more difficult to load and unload when the approach angle is steep, because it takes more force and effort to lift the weight vertically into the cargo area, instead of simply rolling the weight in a more horizontal direction into the cargo area. Further, moving a load up and down a steep angle can be unstable or hard to control, especially for heavy loads or unbalanced loads. Construction equipment and other top-heavy vehicles or vehicles with a high center of gravity, especially, have tipping forces, such that when the top of the vehicle is tilted too far relative to the horizontal axis, the load becomes difficult to control and unstable. Lastly, cargo loads on loading devices such as forklifts, hand pallet trucks, dollies, and other loading devices are hard to control and can be unstable ascending a steep approach angle loading surface. Therefore, a need exists for a low approach angle loading assembly, so that loading and unloading can be performed with less force and with more control.

Moreover, to use a steep approach angle loading surface has additional costs of additional manpower, extra time—especially for set-up, and extra care. Extra equipment, such as hoists, winches, and forklifts, maybe required to lift the load into the cargo area, instead of rolling the load into the cargo area. This extra equipment can reduce the payload, if this equipment must also be towed or taken along with the material handling vehicle. Otherwise, without the ability for this additional help or the ready availability of this additional help, say in remote locations, loading and unloading of cargo may be very difficult, if not impossible to accomplish. Therefore, there exists a need for a more efficient cargo loading and unloading assembly, and a less costly means for loading and unloading cargo, especially without the need of additional manpower or equipment.

Another problem with material handling vehicles or tow trucks from steep approach angle loading surfaces is that the loading surface becomes an obstacle in itself to loading cargo. This problems is especially obvious when loading and unloading cargo with low ground clearance, especially vehicles with low ground clearance, such as exotic cars. That is, static parts of the cargo contact the loading surface during loading and unloading. Using a steep approach angle loading surface, vehicle cargo can have inadvertent, accidental contact with the loading surface during loading and unloading that is undesirable. In this way, the loading surface of the truck can interfere with and obstruct the loading of cargo into the cargo area, and otherwise, make the loading of cargo difficult or impossible. More acutely, the body or chassis of vehicle cargo can contact the loading surface and can become scraped, dented, or otherwise damaged. Exotic cars, sports cars, race cars, and other vehicles with low ground clearance from the bottom of the body or the chassis to the ground surface are especially vulnerable to this unwanted contact and potential damage. This problem poses an urgent need for these vehicles, because of their exceptionally high value, the great financial and emotional expenses of repairs, and the great difficultly of repairing them. For these reasons, these low ground clearance cars are difficult to load onto existing material handling vehicles and may consequently be excluded from this type of transport. To remedy this situation, operators often have to build “make-shift” ramp structures to use with the existing loading surface of the truck to reduce the approach angle. Therefore, a need exists for a low approach angle loading surface for a material handling vehicle and/or tow truck to make loading and unloading cargo easier, such that inadvertent contact between the cargo and the loading surface is limited or prevented. Further, the need exists to enable the loading and unloading of vehicles having low ground clearance, such as exotic cars.

Existing flatbed tow trucks are also limited in that they are not configured to engage various ground surfaces. Currently, the retractable bed and loading surfaces directly contact the ground surface along a rear edge. This configuration becomes a problem when the ground surface is uneven, bumpy, or has different heights, and existing beds and loading surfaces cannot fully engage the ground surface along one edge. In this way, existing beds and loading surfaces may be unstable and difficult to load, especially since the rear edge may not be fully supported on the ground surface. Excessive stress may be placed upon the bed as it may deflect under load until it deflects to engage the ground surface. Therefore, a need exists for flatbed tow trucks to have beds and loading surfaces that can be adjusted to the condition of various ground surfaces.

An additional limitation of existing material handling vehicles and/or tow trucks is that exist beds and loading surfaces do not travel easily on the ground surface. This situation makes it difficult to adjust the position of the bed as it engages the ground surface. Also, the ground surface can be damaged during engagement with the bed or the loading ramps. Therefore, a further need exists for a material handling vehicle and/or tow truck that has a bed or a loading surface configured to smoothly and easily travel on the ground surface to make positioning on the ground surface easier and to protect the ground surface from damage during engagement with the bed or the loading surface.

Current flatbed tow trucks are also limited in that the bed is not configured to be totally off-loaded or removed from the truck to a ground surface, without disconnecting several parts of the bed from the truck. In this way, total off-loading is inconvenient and difficult. Hence, the truck is essentially only configured for one bed, and one bed can only be loaded with one load of cargo at any one time. Therefore, a need exists for a flatbed type tow truck and a bed configured such that the bed can completely offloaded, in an easy and efficient manner. In this way, many beds may be loaded at one time and stored, possibly waiting for transportation by the truck.

Lastly, many existing material handling vehicles require that cargo being lifted by special lifting equipment, like fork lifts, into the cargo area or that must be loaded from a specifically configured loading dock having the height approximately equal to the height of the cargo area. Cargo cannot be directly rolled or moved into the cargo area directly from ground level. These ways of loading may be appropriate in some applications and for some types of cargo, however, they have many limitations. The lifting equipment, operators, and the loading docks are not always nearby or available. Many businesses, whether home-based, in a strip mall, or which otherwise do not have ready access to lifting equipment or have the amenity of a loading dock, would have great difficult loading and unloading cargo. Therefore, a need exists for making material handling and transporting cargo easier and more accessible for all types of locations, homes, and businesses, by especially making the loading and unloading of cargo onto and from material handling vehicles easier and more accessible.

### BRIEF SUMMARY OF THE INVENTION

The above-identified needs and other needs are met or exceeded by the present low approach angle flatbed assembly. The present invention is usable with a material handling vehicle and/or tow truck. It has a flatbed assembly that can be lowered off of the truck to a loading position that is very low to a ground surface. It has bed or deck and a ramp portion that create a low approach angle loading surface to a cargo area of the bed. The bed and ramp portions can achieve such low dimensions, in part, because of a low profile support structure, which is partially located outside of the dimensions of the bed. The cargo area and the ramp portion are also partially built into the sub-frame of the flatbed assembly. Longitudinal support rails are configured at opposite sides of the bed, and the ramp portion is recessed between the longitudinal support rails and built into the sub-frame. In this way, the present invention provides a low approach angle structure in which cargo, especially vehicles with low ground clearance, can be easily loaded and unloaded into the cargo area without obstruction from the loading surface and with less loading effort or force and more control of the cargo load.

More specifically, the present invention provides a flatbed assembly for a material handling vehicle with a bed configured to support a very heavy cargo load during transportation, loading, and unloading. A receptacle of the flatbed assembly engages the material handling vehicle, such that a positioning apparatus on the material handling vehicle can completely move the flatbed assembly off of the material handling vehicle to a cargo loading position on the ground and can move the flatbed assembly from the cargo loading position to a transporting position on the material handling vehicle, with or without a load of cargo. In this way, the positioning apparatus and receptacle adjust the vertical elevation of the flatbed assembly. At least one landing gear assembly is configured at the rear of the bed to engage a ground surface during positioning of the flatbed assembly and to minimize the height of said bed relative to the ground surface. This structure and action further allows the flatbed assembly to have a low angle with the ground surface and a low approach angle for loading and unloading cargo.

The landing gear assembly or assemblies further enable the present invention to achieve a low approach angle by engaging the ground surface outside of the dimensions of the flatbed assembly. An extension arm of the landing gear assembly extends out beyond the rear end of the ramp portion. This configuration supports the flatbed assembly from a position outside of the length and width dimensions of the bed and the ramp portion. This support position allows the flatbed assembly to lower very close to the ground without interfering below the flatbed assembly. The landing gear assembly is also configured to support a very heavy cargo load during flatbed positioning. Therefore, the flatbed assembly can be positioned in a low approach angle, and it meets the needs for easily and efficiently loading cargo onto a material handling vehicle.

The landing gear assembly or assemblies of the present invention provide a structure for quickly, easily, and efficiently positioning the flatbed assembly for loading, unloading, and transporting cargo. The landing gear assembly is the first contact point with the ground surface, and it engages the ground surface by traveling smoothly and easily on the ground surface. The landing gear assemblies allow the flatbed assembly to be easily positioned on the ground as the flatbed assembly is being off-loaded from the truck. The landing gear assemblies contact the ground beyond the rear end of the flatbed assembly. Therefore, the landing gear assemblies make first contact with the ground and prevent the edges of the ramp portion or the flatbed assembly from interfering with the ground surface and contacting the ground until the flatbed assembly can stop traveling and be lowered to a ground position. Further, the landing gear assemblies can pivot the flatbed assembly to the ground position, stably lowering the flatbed assembly to contact the ground after all travel and positioning on the ground surface has been completed.

Also, the landing gear assembly protects the ground surface from damage as it is being positioned. A wheel or wheels of the landing gear assemblies provide that the flatbed assembly rolls on the ground as it travels. The rolling-type of engagement of the present invention with the ground surface helps protect the ground surface from gauging, scraping, and other type of damage from contact with the bed or ramp portion, even under cargo load.

The landing gear assembly or assemblies can be adjusted and, likewise adjust the flatbed assembly to various ground surface condition, such as uneven terrain and bumpy ground. An adjustment mechanism of the landing gear assembly can change the height of the landing gear assemblies relative to the ground surface. Changing the height position of the landing gear assemblies can further change the height of the ramp portion at the rear of the flatbed in relation to the ground. Having more than one landing gear assembly can change the height of the ramp portion relative to the ground at different points transversely located along the rear edge of the ramp portion, giving the flatbed assembly more direct engagement with the ground and more stability on uneven ground surfaces.

The landing gear assembly is also made simply with a minimal amount of parts to maximize the payload of the truck. The flatbed assembly can be completely off-loaded from the truck. Multiple beds can be used with the same truck. The beds can be stored with cargo for future use. The flatbed assembly can be used for transporting vehicles and other types of cargo. One embodiment of the present invention has an enclosure of the on top of the bed. Another embodiment of the present invention is usable with a typical cargo container.

### BRIEF DESCRIPTION OF THE DRAWINGS

FIG. 1 is a perspective view of the preferred embodiment of the present flatbed assembly;

FIG. 2 is a top view of the preferred embodiment of the present flatbed assembly;

FIG. 3 is a side view of the preferred embodiment of the present flatbed assembly;

FIG. 4 is a front view of the preferred embodiment of the present flatbed assembly while in a cargo loading position on an uneven ground surface having multiple landing gears adjusted to different heights relative to the ground surface;

FIG. 5 is a partial side view, in section, of a landing gear assembly of the preferred embodiment of the present flatbed assembly taken along section lines 5-5 of FIG. 2, showing pivoting motion.

FIG. 6a is a side view of the preferred embodiment of the present flatbed assembly in the transport position on a material handling vehicle;

FIG. 6b is a side view of the preferred embodiment of the present flatbed assembly on a material handling vehicle during off-loading and positioning;

FIG. 6c is a side view of the preferred embodiment of the present flatbed assembly in the ground position with a material handling vehicle;

FIG. 7 is a top view of another embodiment of the flatbed assembly having an enclosure;

FIG. 8 is a side view of another embodiment of the flatbed assembly having an enclosure;

FIG. 9 is a front view of another embodiment of the flatbed assembly having an enclosure;

FIG. 10 is a top view of another embodiment of the flatbed assembly having a cargo container;

FIG. 11 is a side view of another embodiment of the flatbed assembly having a cargo container; and

FIG. 12 is a front view of another embodiment of the flatbed assembly having a cargo container.

### DETAILED DESCRIPTION OF THE INVENTION

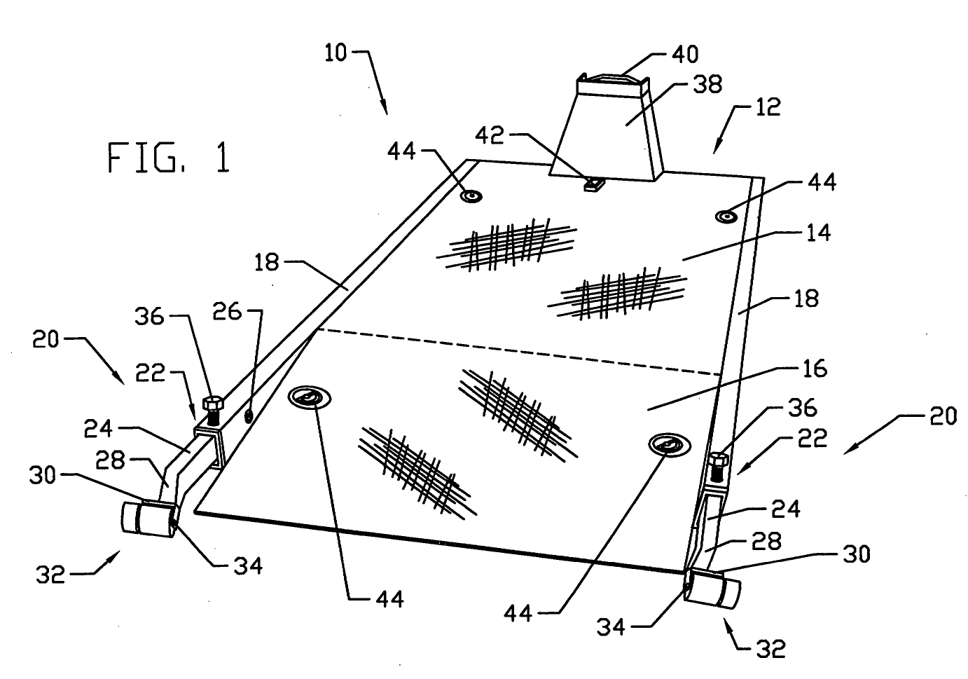

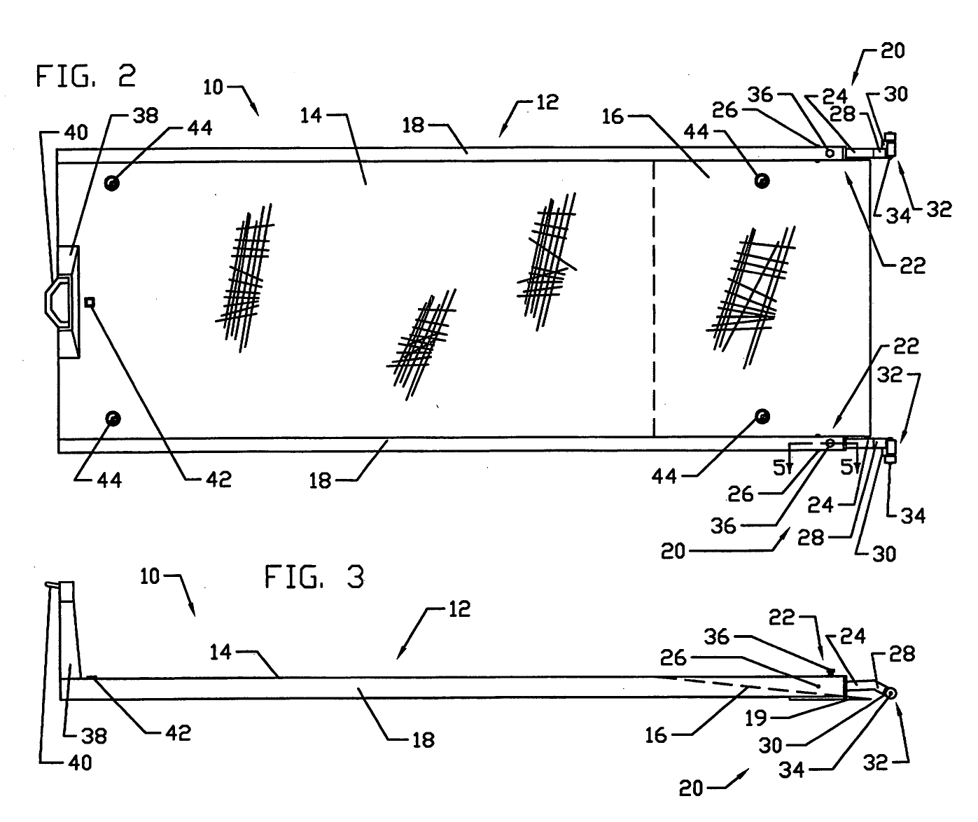

In FIGS. 1-6c, drawings of a preferred embodiment are depicted. Referring now to FIGS. 1-3, a low approach angle flatbed assembly is generally designated 10 usable on a material handling vehicles and/or tow trucks that transport cars, especially exotic cars with low ground clearance, recreational vehicles, construction vehicles, and other types of vehicles that would benefit from a low approach angle flatbed. The flatbed assembly includes a bed, generally designated 12, configured to support and secure a very heavy cargo load, which is not shown, during transportation, loading and unloading. The bed 12 includes a cargo area portion 14 at the front of the bed 12 and ramp portion 16 at the rear of the bed 12. The bed 12 is supported between two longitudinal support rails 18 that extend longitudinally from the front of the flatbed assembly 10 to a location near, but not past the rear end of the ramp portion 16. The ramp portion 16 is downwardly and angularly recessed between the longitudinal support rails 18. The ramp portion 16 extends beyond the rear end of the longitudinal support rails 18. Best shown in FIG. 3, a ramp support 19, supports the bottom of the ramp portion 16.

Further shown in FIGS. 1-3, landing gear assemblies, generally designated 20, extend rearward from longitudinal support rails 18 at landing gear support receptacles 22 and extend past the end of the ramp portion 16. The landing gear assemblies 20, each have an extension arm 24 that pivots within the rear end of a longitudinal support rail 18 on a pivot pin 26. Each extension arm 24 extends out of the rear end of a longitudinal support rail 18 to an angled portion 28. The angled portion 28 extending from the rear end of the extension arm gives the extension arm more strength and leverage as it is angled downward toward a ground surface 29. The angled portion 28 extends downward angularly to a wheel bracket 30 that supports at least one wheel 32 by a wheel pin 34. The wheel or wheels 32 are the contact points with the ground surface 29 as the flatbed assembly 10 is lowered and positioned. The wheels 32 provide rotational movement and contact with the ground surface 29. The wheels 32 also support the flatbed assembly 10 outside of the length and width dimensions of the flatbed assembly 10. The wheels 32 are located at the furthest rear position of the flatbed assembly 10. The wheels 32 are located past the rear end of the bed 12 and, also, outside of the width of the bed 12. This location for the wheels 32 allows the bed 12 and ramp portion 16 to be lowered without being obstructed by the landing gear assembly 20 or any ground support system. Also located near the rear of the longitudinal supports rails 18 are adjustment screws 36 of the landing gear assembly 20.

The flatbed assembly 10 has a hook tower 38 and a hook receptacle 40. The bed 12 has a winch receptacle 42 that can support a winch apparatus, not shown. The bed 12 also has load tie down receptacles 44 for strapping a cargo load, not shown, to the bed 12, and for restraining and securing the cargo load on the bed 12 especially during loading, unloading and transporting the cargo load.

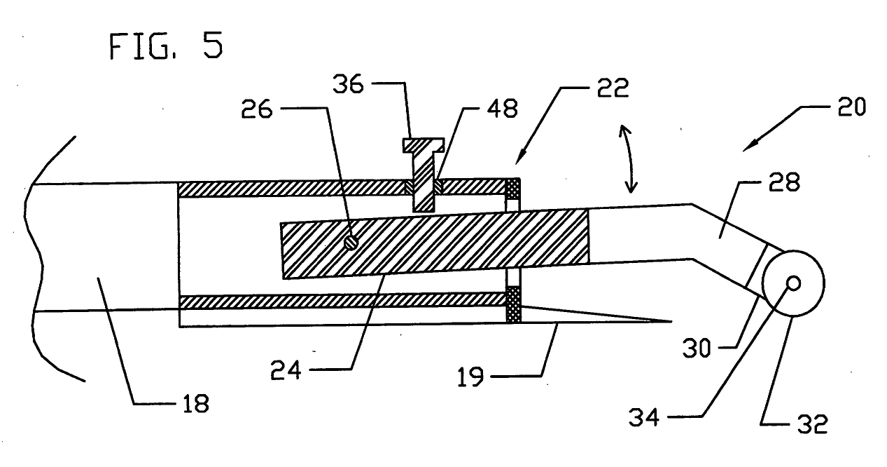

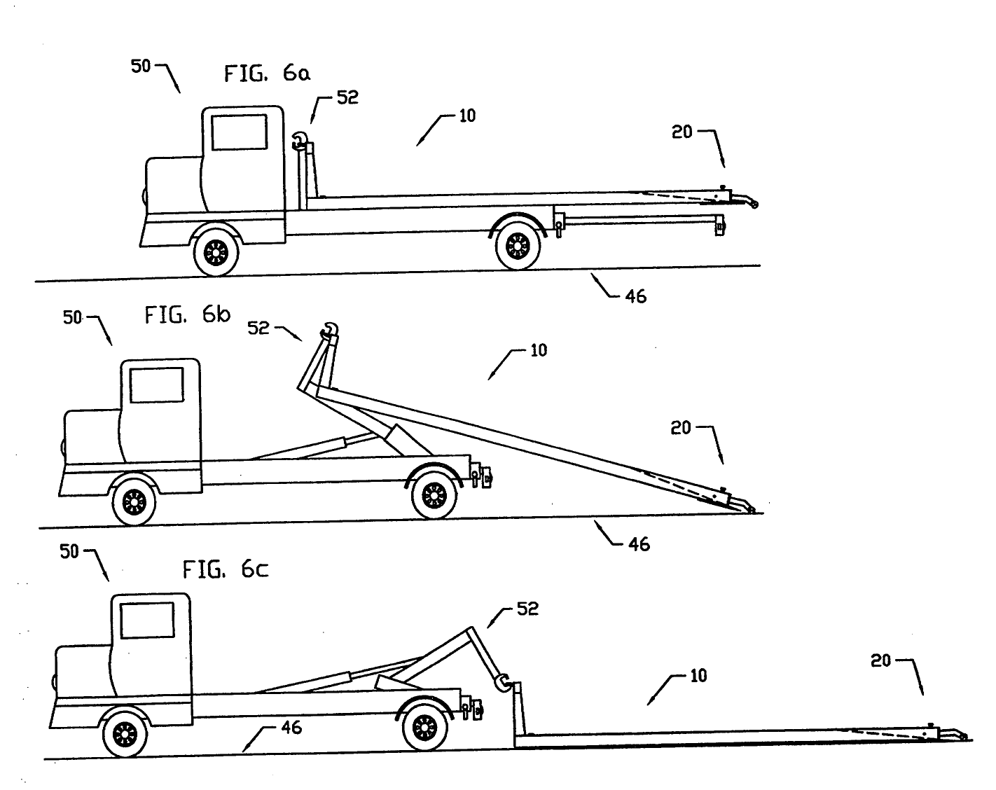

FIG. 5 is a partial sectional view taken along lines 5-5 in FIG. 2 and best shows the landing gear assembly 20 of the preferred embodiment. The extension arm 24 resides within the landing gear support receptacle 22, which is a hollow portion at the rear of the longitudinal support rail 18. The extension arm 24 is supported and secured within the support receptacle 22 by the pivot pin 26. The pivot pin 26 allows the extension arm 24 to move radially, as shown by the directional arrows in FIG. 5. The landing gear support receptacle 22 has an open end and a hollow space within which the extension arm 24 can move when pivoting. The extension arm 24 extends rearwardly out of the support receptacle 22 to the angled portion 28, which is angled rearward and downward from the extension arm 24. The angled portion 28 reduces the amount of pivoting motion of the extension arm 24 that is required for the landing gear assembly 20 to contact a ground surface 29, which will be further depicted in FIG. 6b. Yet, the angled portion 28 also provides an earlier opportunity for the landing gear assembly 20 to contact the ground surface 29 as the flatbed assembly 10 is lowered. Further, the angled portion 28 raises the height of the landing gear assembly 20 and provides more ground clearance for the rear end of the flatbed assembly 10, so that the rear end of the flatbed assembly 10 can be lowered further to the ground surface 29. The angled portion 28 extends to the wheel bracket 30 that holds the wheels 32 via a wheel pin 34. The size, structure, and materials of the wheels 32 can be changed to change how the landing gear 20 is positioned and configured, to support different weights of cargo loads, and to best contact and travel on different kinds of ground surfaces 29.

The adjustment screw 36 adjusts the position of the landing gear assembly 20 by changing the range of motion of the extension arm 24. The adjustment screw 36 is threadably attached to the longitudinal support rail 18 near the rear end by an adjustment thread 48, which is located within the top of the longitudinal support rail 18. The adjustment screw 36 can be screwed into and out of the support receptacle 22 via the adjustment thread 48. The adjustment screw 36 stops the extension arm 24 within the support receptacle 22. As the adjustment screw 36 is screwed into the support receptacle 22, it reduces the radial range of motion of the extension arm 24, and when the adjustment screw is screwed out of the support receptacle 22, it increases the radial range of motion of the extension arm 24. Thus, changing the height of the adjustment screws 36, adjusts vertical distance of the ramp portion 16 to the ground surface 29. These adjustments are made at ground level, which makes the adjustments easier and more precise. Other types of adjustment mechanisms and configurations may be evident to one skilled in the art without departing from the spirit and scope of the present invention as claimed.

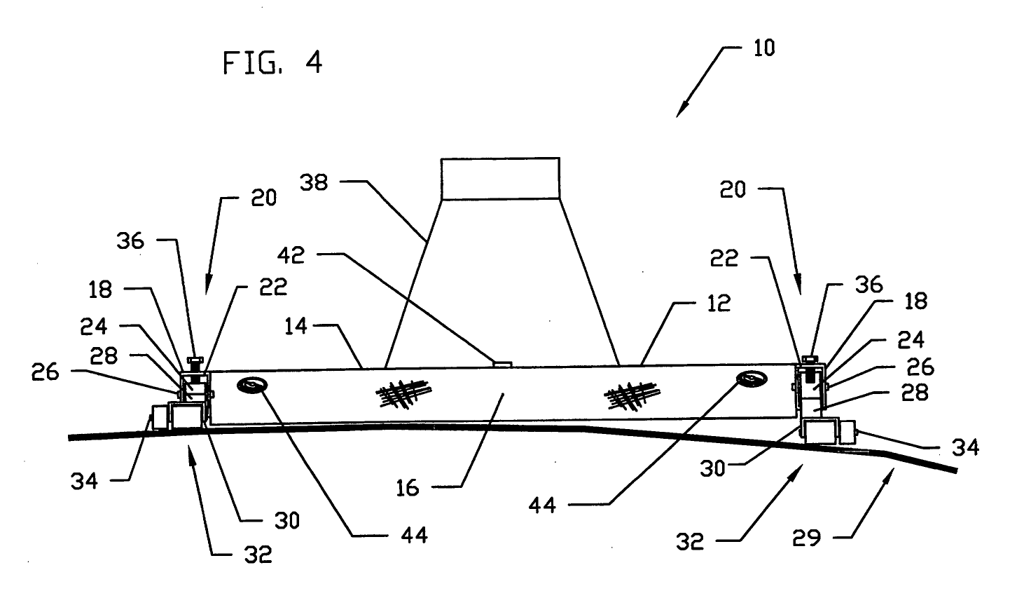

FIG. 4 best shows the positioning and adjustability of the landing gear assembly 20. In FIG. 4, the flatbed assembly is in the loading position, best depicted in a side view in FIG. 6c, however, in FIG. 4, the ground surface 29 is uneven. As depicted in FIG. 4, the adjustment screws 36 have been screwed into the support receptacles 22 to differing heights via the adjustment threads 48. The results of this adjustment is that the landing gear assemblies 20 have different heights and the rear of the flatbed assembly has different heights at opposite ends. This present configuration allows the flatbed assembly to better and more stably support a cargo load on an uneven ground surface 29 as shown in FIG. 4.

FIGS. 6a-6c depict different positions of the preferred embodiment of the flatbed assembly 10 on a material handling vehicle and/or tow truck, generally shown as 50. FIG. 6a shows the transporting position of the flatbed assembly 10, where the flatbed assembly is completely off of the ground surface 29 and completely supported on the material handling vehicle 50. The position of the flatbed assembly 10 in FIG. 6b is called the off-loading position, where the flatbed assembly 10 is being moved from the material handling vehicle 50 and being positioned on the ground surface 29. This position is the same as when the flatbed assembly is being moved onto the material handling vehicle 50 from the ground surface 29. Lastly, FIG. 6c depicts the ground position, where the flatbed assembly 10 has been completely off-loaded from the material handling vehicle 50 to be supported on the ground surface 29.

In the off-loading position, as shown in FIG. 6b, the landing gear assemblies 20 first contact the ground surface 29, as the rear of the flatbed assembly 10 is lowered and moved rearward. The wheels 32 located at the points furthest to the rear facilitate movement on the ground surface 29. The landing gear assemblies 20 provide clearance between the ground surface 29 and the ramp portion 16, as the flatbed assembly 10 moves into the ground position. The landing gear assemblies 20 can be adjusted at ground level such that the ramp portion 16 contacts the ground surface 29 in a desired position. The landing gear assemblies 20 can actually just vertically set the ramp portion 16 on the ground surface 29 after horizontal travel on the ground surface 29 has stopped and as the front end of the flatbed assembly 10 is also lowered. This prevents the ramp portion 16 from scrapping or damaging the ground surface 29. It also allows the ramp portion 16 to be better supported on uneven, bumpy, and/or, a non-flat surface, as the height of the ramp portion 16 can change relative to the ground surface 29, as adjustments to the landing gear assemblies 20 are made. FIG. 6c shows the ramp portion 16 in complete contract with the ground surface 29.

FIG. 6c also depicts the very low approach angle of the ramp portion 16. The ramp portion 16 is angularly configured, extending rearward from the cargo area 14 and downward toward the bottom of the flatbed assembly 10. The ramp portion 16 is configured such that when the flatbed assembly 10 is in a loading position, best depicted in FIG. 6c, the ramp portion 16 has a very small incline from a ground surface 29 to the cargo area 14. Cargo, especially vehicles with low ground clearance (not shown), can be driven or pulled into the cargo area easily and safely via the low approach angle without interference from the loading surface or ramp portion 16. The bed 12, itself, is configured as shown in FIG. 6c, such that it will not interfere or obstruct the loading of cargo. Further, loading devices, such as forklifts (not shown), can easily ascend and descend the ramp portion 16 into the cargo area 14.

Also shown in FIGS. 6a-6c, is the engagement between the flatbed assembly 10 and the hook-lift type of lifting and positioning apparatus 52 of the material handling vehicle 50. In FIG. 6a, the hook receptacle 40 is fully engaged with the hook-lift 52, securing the flatbed assembly 10 on the material handling vehicle 50. In FIG. 6b, the hook receptacle 40 is pivotably engaged with the hook-lift 52 as the front of the flatbed assembly 10 is lifted and moved rearward, and the rear of the flatbed assembly 10 is lowered off of the material handling vehicle 50 to the ground surface 29. FIG. 6c further shows the pivotable engagement between the hook receptacle 40 and the hook-lift 52 as the front of the flatbed assembly 10 is lowered to the ground surface 29. FIG. 6c also shows the releasable engagement between the hook receptacle 40 and the hook-lift 52, as the hook receptacle 40 can detach from the hook-lift apparatus 52 through an opening in the hook-lift 52. In this way, the flatbed assembly 10 can be completely off-loaded onto the ground surface 29 and completely released from the material handling vehicle. Typical positioning apparatuses 52 may be actuated by a manual, mechanical, and/or hydraulic system. Other configurations for the positioning apparatus 52 may be evident to one skilled in the art without departing from the spirit and scope of the present invention as claimed.

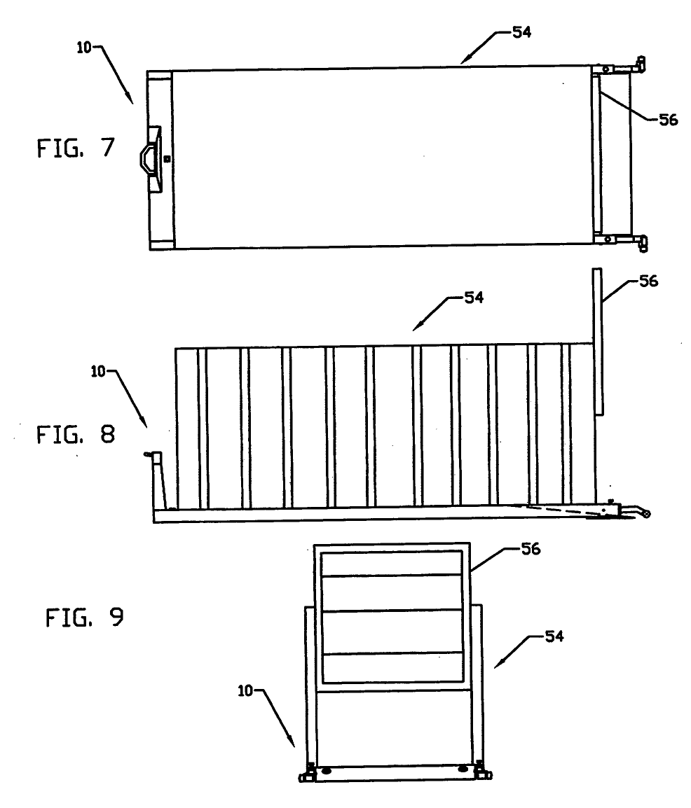

FIGS. 7-9 show an alternative embodiment of the present invention, in which a vehicle enclosure 54 is mounted on the top of the flatbed assembly. The vehicle enclosure 54 includes a door 56. The vehicle enclosure 54 provides further protection for cargo, especially exotic cars and other expensive cars, during transportation and storage.

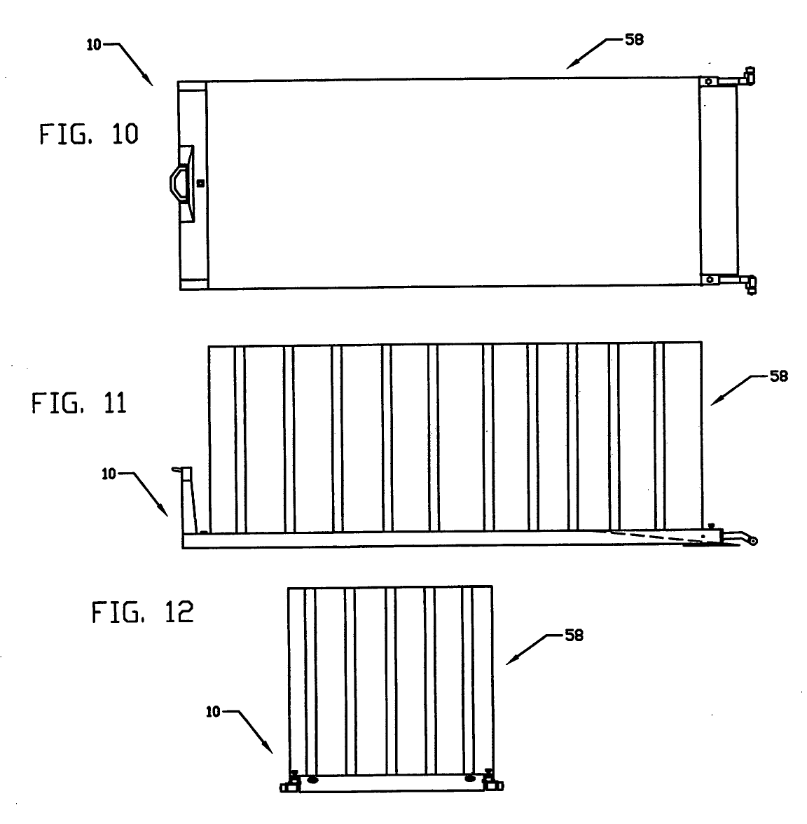

FIGS. 10-12 depict a further embodiment of the present invention, in which the flatbed assembly 10 is configured to support a typical cargo container 58. The present invention can be configured to be usable with a typical cargo container 58, such that the flatbed assembly 10 having a cargo container 58 can be completely off-loaded for storage independent of the material handle vehicle. This configuration provides a way for cargo containers 58 to be loaded and unloaded without the use of heavy lifting machines and equipment. The material handling vehicle can perform all of the lifting independently.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

1) A flatbed assembly for a material handling vehicle, the flatbed assembly comprising:
a bed configured to support a cargo load during transportation, loading and unloading;
a means for engaging the material handling vehicle, such that a positioning apparatus on the material handling vehicle can completely move the flatbed assembly off of the material handling vehicle to a cargo loading position and can move the flatbed assembly from the cargo loading position to a transporting position on the material handling vehicle, with or without a load of cargo; and
a landing gear assembly configured at the rear of said bed to engage a ground surface during positioning of the flatbed assembly and to minimize the height of said bed relative to the ground surface.

2) The flatbed assembly of claim 1, wherein the flatbed assembly in the cargo loading position is fully off-loaded from the material handling vehicle and positioned onto the ground surface, and, in the transporting position, is fully and securely positioned on the material handling vehicle.

3) The flatbed assembly of claim 1, wherein said means for engaging a positioning system includes a hook tower and a hook receptacle that is configured to engage a hook of a hook-lift type of positioning system of the material handling vehicle.

4) The flatbed assembly of claim 1, wherein said landing gear assembly further comprises:
an extension arm; and
a means for contacting the ground surface located at the distal end of said extension arm such that friction is reduced between the flatbed assembly and the ground surface and movement of the flatbed assembly on the ground surface is facilitated.

5) The flatbed assembly of claim 4, wherein said extension arm is pivotably attached to the flatbed assembly.

6) The flatbed assembly of claim 5, wherein said extension arm is rotatable relative to said bed such that it can reduce the height of said bed to the ground surface in the cargo loading position.

7) The flatbed assembly of claim 5, wherein said extension arm pivots said means for contacting the ground surface to facilitate movement of the flatbed assembly on the ground surface.

8) The flatbed assembly of claim 4, wherein said extension arm further includes an angled portion.

9) The flatbed assembly of claim 8, wherein said angled portion further reduces the height of said bed relative to the ground surface in the cargo loading position.

10) The flatbed assembly of claim 4, wherein the means for contacting the ground surface is at least one wheel.

11) The flatbed assembly of claim 4, further including a means for adjusting the position of said landing gear assembly.

12) The flatbed assembly of claim 11, wherein said means for adjusting the position of said landing gear assembly includes:
an adjustment screw; and
a locator thread.

13) The flatbed assembly of claim 12, wherein said adjustment screw is screwable in said locator thread to configure said landing gear assembly to position said bed vertically to the ground surface.

14) The flatbed assembly of claim 1, wherein the flatbed assembly includes a plurality of landing gear assemblies such that each assembly is independently adjustable, making each capable of adjusting said bed vertically to the ground surface and enabling a rear contact edge to more completely engage the ground surface, especially when the ground surface is uneven, bumpy, or not flat.

15) The flatbed assembly of claim 1, wherein said bed further includes:
a cargo area portion at the front of said bed; and
a ramp portion at the rear of said bed.

16) The flatbed assembly of claim 15, wherein said ramp portion is angularly configured, extending rearward from said cargo area portion and downward toward the bottom of said flatbed assembly such that, when the flatbed assembly is in the loading position said ramp portion creates a very small incline from the ground surface to said cargo area portion.

17) The flatbed assembly of claim 15, further including:
a plurality of longitudinal support rails between which said bed is supported.

18) The flatbed assembly of claim 17, wherein said plurality of longitudinal supports rails support said landing gear assembly outside of the dimensions of said bed limiting structural obstructions between the bed and the ground surface and allowing said bed to be lowered closer vertically to the ground surface; and
wherein said ramp portion is angularly recessed between said longitudinal support rails to limit structural obstructions and allowing said ramp portion to be further angularly extendable downward and rearward.

19) The flatbed assembly of claim 1, further including an enclosable housing capable of containing a vehicle.

20) The flatbed assembly of claim 1, wherein said bed is configurable to load and transport cargo shipping containers.

21) A combination of a hook-lift type of tow-truck and a flatbed assembly configured to engage and operate with a hook-lift type of tow-truck.

22) A method of using a flatbed assembly for loading a vehicle onto a tow truck including:
a) moving a flatbed assembly off of a rear end of the tow truck using a hook-lift type actuation mechanism of the tow truck;
b) engaging a ground surface in back of the rear end of the tow truck with the flatbed assembly using a plurality of landing gear assemblies that facilitate movement of the flatbed assembly on the ground surface;
c) while lowering the flatbed assembly, pivoting the flatbed assembly using a pivotable extension arm on each of the plurality of landing gears extending beyond the rear of the flatbed assembly such that a bed on the flatbed assembly is lowered into near proximity to the ground surface and a ramp portion at the rear of the flatbed assembly has a low approach angle for ascent by cargo;
d) moving the flatbed assembly to a position completely past the rear end of the tow truck and lowering the flatbed assembly to a loading position such that the flatbed assembly is completely off-loaded from the tow truck and positioned onto the ground surface;
e) adjusting the height of the ramp portion at the rear of the flatbed assembly by screwing adjustment screws in locating threads to force the extension arms higher or lower relative to the ground surface;
f) adjusting the angle of the ramp portion relative to the ground surface by screwing the adjustment screws in the locating threads such that the plurality of landing gears assemblies changes vertical distance of the ramp portion to the ground surface at different transverse point along the rear of the ramp portion;
f) rolling a cargo vehicle up the ramp portion into a cargo area of the bed;
g) securing the cargo vehicle on the flatbed assembly for transporting;
h) engaging a hook receptacle on the flatbed assembly with the hook-lift type actuation mechanism of the tow truck; and
i) lifting the flatbed assembly with the hook-lift type mechanism and moving the flatbed assembly, having cargo load, forward into a transporting position on the tow truck.
